(19) United States
(12) Patent Application Publication
(10) Pub. No.: US 2006/0235788 A1
(43) Pub. Date: Oct. 19, 2006

(54) Student loans consolidation matching system and method

(76) Inventor: Allan Guyton, Fredricksburg, VA (US)

Correspondence Address: SMITH, GAMBRELL & RUSSELL, SUITE 3100, PROMENADE II, 1230 PEACHTREE STREET, N.E., ATLANTA, GA, 30307-3592, US

(21) Appl. No.: 10/848,839

(22) Filed: May 19, 2004

Related U.S. Application Data
(60) Provisional application No. 60/471,548, filed on May 19, 2003.

(51) Int. Cl. G06Q 40/00

(52) U.S. Cl. 705/38

(57) ABSTRACT

The present invention provides an electronic system and method for automatically matching a prospective borrower seeking consolidation of student loans to one or more programs of prospective Federal Family Education Loan (FFEL) loan providers offering loan programs that match the borrower's loan circumstances.

### CROSS-REFERENCE TO RELATED APPLICATION

This application claims the benefit of priority of U.S. provisional application No. 60/471,548, filed May 19, 2003, which is incorporated herein by reference.

### BACKGROUND

The Higher Education Act (HEA) provides for a loan consolidation program under Federal Family Education Loan (FFEL) and Direct Loans. Under these programs, a borrower's underlying loans are paid off and a new consolidation loan is created, typically at more favorable interest rates and/or favorable extended repayment periods.

Under the Direct Loan Program, the US government acts as the lender and funds the consolidation loan. Conversely, private loan providers such as lenders including banks, credit unions, educational institutions or other private lenders, including loan providers partnering with lenders, lend or originate the consolidation loan under the FFEL Program.

Because the government subsidizes the interest on FFEL loans (up to 8.25%) to the private loan providers, and the investment in the loan has a guaranteed return, private loan providers enjoy a strong incentive to make FFEL consolidation loans. Accordingly, each loan provider typically offers various incentives, such as significant rate reductions for on-time payments and electronic payments, to encourage borrowers to originate their loans with the loan provider. As a result, borrowers enjoy many choices for a for originating a consolidation loan under the FFEL program.

However, not all loan providers service all types of loans for FFEL consolidation, and many loan providers have minimum loan amount requirements. Unfortunately, most borrowers searching for a particular interest rate or incentive do not realize that a program is not available under their loan circumstances until attempting to qualify and failing to meet the requirements of a particular loan provider. Much of this confusion results from the present decentralized marketplace in which borrowers and loan providers simply search for one another, such as through Internet searches (borrowers) and conventional and electronic mailings (loan providers).

Accordingly, there is a need for a centralized and automated system for borrowers to determine which lender FFEL consolidation programs are available under the borrower's loan situation and provide loan providers with potential applicants that meet the requirements of the loan provider's loan program.

### SUMMARY OF THE INVENTION

The present invention provides a system and method for matching borrowers to FFEL consolidation loan providers electronically via a computer network, such as the Internet. In an embodiment of the invention, the system is provided in an Application Service Provider (ASP)-model.

In an embodiment of the invention, prospective borrowers enter through a “borrower” web interface their loan data, contact information, and other details required on a Federal Consolidation Application & Promissory Application. Loan providers enter through a “loan provider” interface contact information and specific criteria, such as types of loans serviced, whether defaulted loans accepted, and other criteria, required for determining whether a borrower's circumstances would qualify that borrower for the loan provider's consolidation loan program. The borrower and loan provider information is stored in an associated database.

The borrower's application/qualification data is compared in the database against federal loan consolidation guidelines and the various loan providers' FFEL loan programs and requirements to determine if the borrower qualifies at all for consolidation, and, if so, which loan providers and programs match the borrower's situation.

The borrower can then choose to receive FFEL loan consolidation application materials from matching programs.

In embodiments of the invention, borrower data may be received by a matching loan provider over a secure server to be incorporated into their processing systems.

In further embodiments of the invention, the centralized website is administered by a third party entity, such as an ASP, who receives a commission for matching the borrower to the loan provider. In certain embodiments, a loan provider may pay a commission for a borrower requesting an application, receiving the application from the borrower and/or originating the consolidation loan.

In other embodiments of the invention, a FFEL federal consolidation program loan provider may receive certain benefits from an ASP administering the centralized matching website based on the value of commissions paid or other priority fees. For example, a loan provider providing higher commissions with programs matching a borrower's circumstances may be listed first in the list of matches provided to a borrower.

### BRIEF DESCRIPTION OF THE DRAWINGS

FIG. 1 is a process flow diagram showing data entry and automated matching of borrowers and loan providers in an embodiment of the present invention.

FIG. 2 is a flow diagram showing the decision logic for searching and matching borrowers to one loan provider or multiple loan providers in an embodiment of the present invention.

FIG. 3 is a screen display for borrower registration in an embodiment of the present invention.

FIG. 4 is a screen display for borrower registration in an embodiment of the present invention.

FIG. 5 is a screen display of loan provider matches in an embodiment of the present invention.

FIG. 6 is a screen display for loan provider login in an embodiment of the present invention.

FIG. 7 is a screen display for loan provider data and loan criteria entry in an embodiment of the present invention.

FIG. 8 is a relational block diagram of a borrower to loan provider consolidation loan matching architecture in an embodiment of the present invention.

### DETAILED DESCRIPTION OF THE INVENTION

Much of the traditional process of loan consolidation involves loan providers (including lenders and partnering companies) and borrowers seeking each other. The present invention provides a centralized and automated system and method for bringing prospective borrowers and lenders together to initiate FFEL consolidation loans.

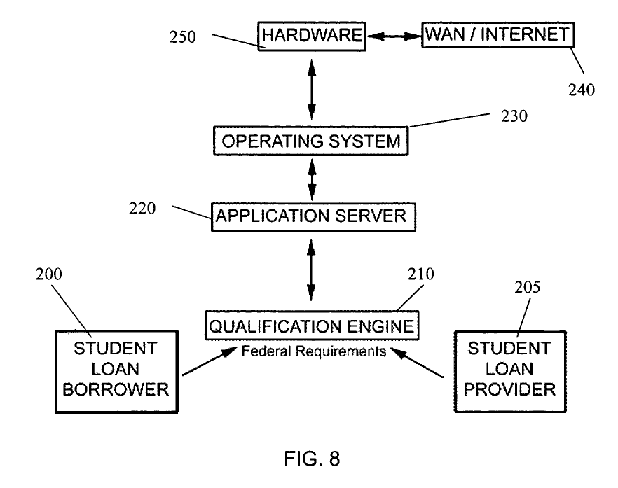

Referring to FIG. 8, in an embodiment of the invention, a website is provided on a wide area network (WAN) 240, such as the Internet. In an exemplary embodiment, an Application Service Provider (ASP)-model of providing a system and services is implemented. The ASP's hardware 250 includes an operating system 230 running an application server 220. A database (or qualification engine) 210 is provided for storing, analyzing and returning data used in embodiments of the invention. It will be appreciated that student loan borrowers 200 and student consolidation loan providers 205 access the system through an interface on a computer connected to the WAN 240.

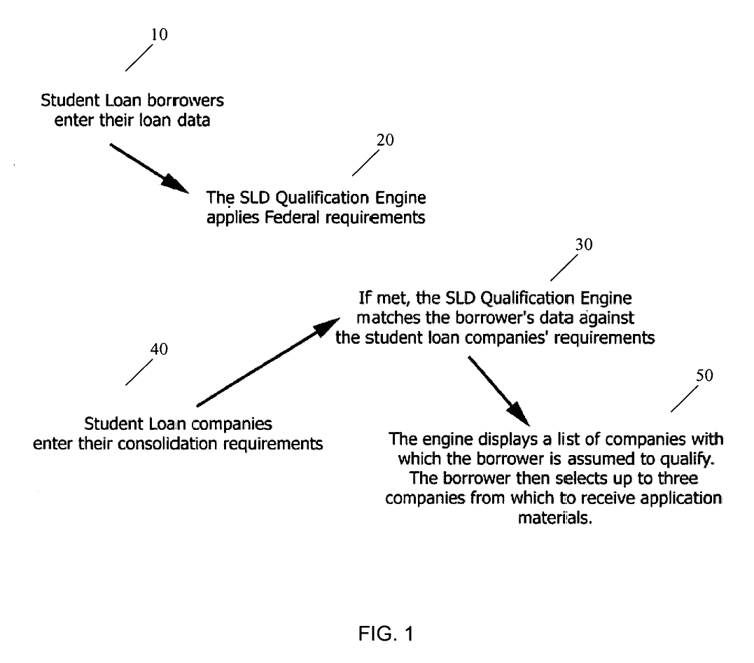

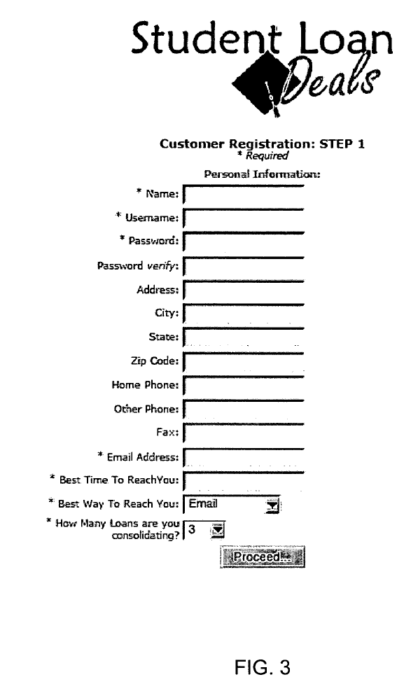

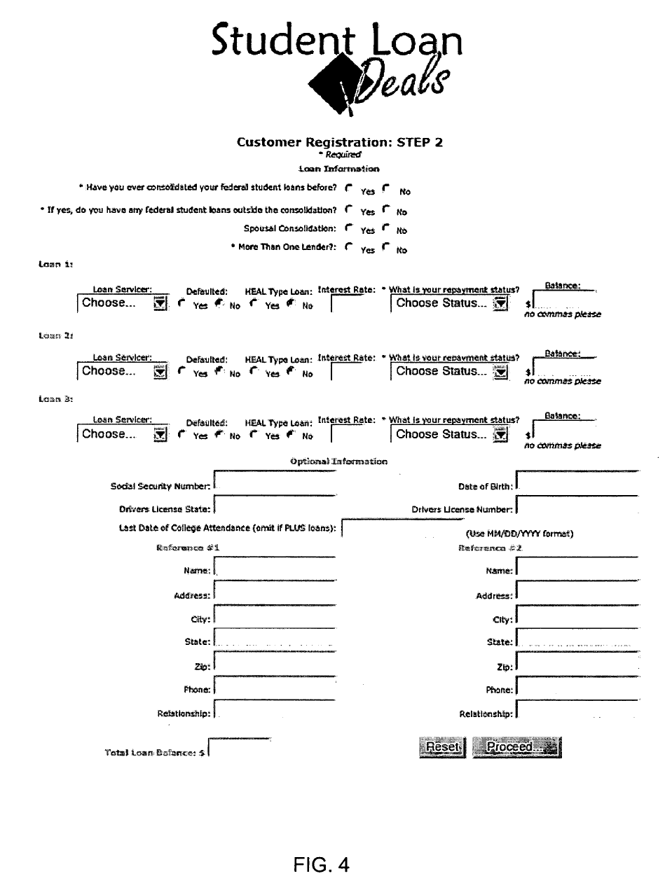

Referring to FIG. 1, at step 10, student loan borrowers 200 seeking an FFEL consolidation loan enter their contact information, loan data, and other details required for the Federal Consolidation Application & Promissory Note via a secure server at the website. FIG. 3 shows a borrower contact information entry screen provided through a web browser interface in an embodiment of the invention. FIG. 4 shows a borrower loan information entry screen provided through a web browser in an embodiment of the invention.

With further reference to FIG. 4, in embodiments of the invention, the borrower 200 enters loan data including: (1) whether they have consolidated federal student loans before, (2) whether they have any federal student loans outside the consolidation, (3) whether the application is for a spousal consolidation, (4) whether they have one or multiple lenders, and (5) a listing of loans to be consolidated, including the loan servicer, whether the loan is defaulted, whether the loan is a Health Education Assistance Loan (HEAL), the interest rate of the loan, the repayment status of the loan, and the remaining loan balance. It will be appreciated that the information entered by a borrower 200 is stored in a database 210.

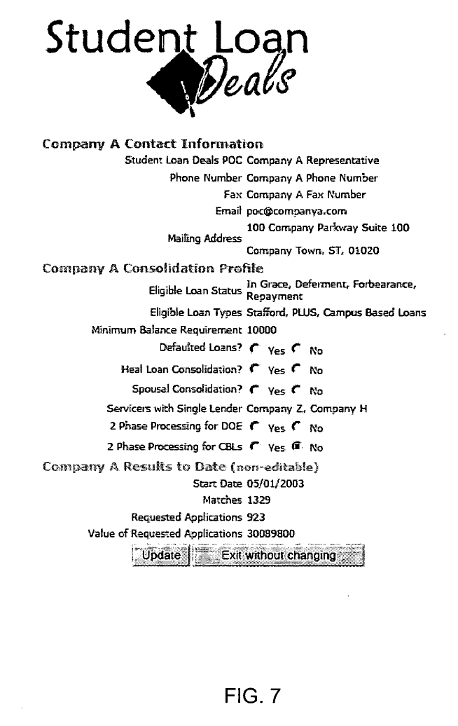

Referring again to FIG. 1, at step 40, loan providers 205 provide data to the system that reflects the consolidation requirements for the FFEL consolidation loan offered by the loan provider 205. In an exemplary browser-based data entry screen shown in FIG. 7, the loan provider 205 provides contact information and a consolidation profile that includes: (1) types of loan status accepted, (2) types of loans eligible for consolidation, (3) minimum balance requirements, (4) whether defaulted loans are accepted, (5) whether HEAL loans are accepted, (6) whether spousal consolidation is accepted, (7) list of companies that lender is able to provide consolidation under “single lender” requirement of HEA, (8) whether two-phase processing is available to avoid “single lender” requirement for Department of Education loans, and (9) whether two-phase processing is available to avoid “single lender” requirement for college-based loans. It will be appreciated that the consolidation requirements for each loan provider 205 are stored in a database 210.

Referring again to FIG. 1, at step 20, a borrower's student loan information is processed in the database 210, in some embodiments referred to as student loan deals qualification engine 210, with respect to federal requirements that must be met to qualify for an FFEL consolidation loan.

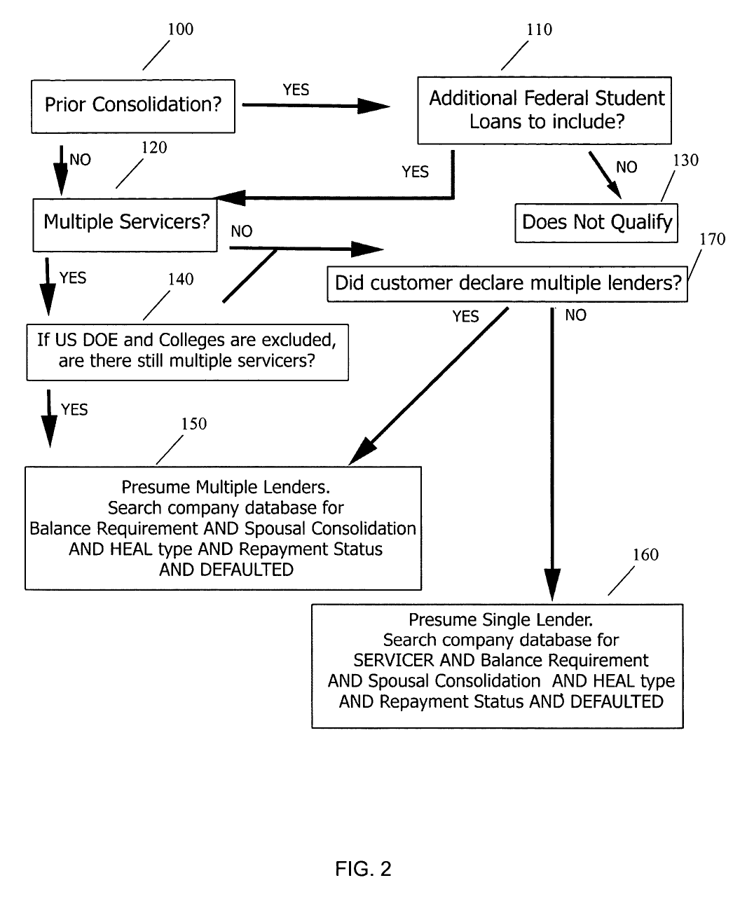

Referring to FIG. 2, the qualification engine 210 at step 100 determines from the borrower loan data whether there has been a prior consolidation. If no, at step 120 the qualification engine 200 determines whether the borrower has multiple servicers of the loans to be consolidated. If the borrower has multiple servicers, at step 140 the qualification engine 210 determines if U.S. Department of Education and college-based loans are excluded, if there are still multiple servicers. If yes, at step 150, the qualification engine presumes the borrower 200 has multiple lenders, and the engine will proceed to match the borrowers data against the loan providers' consolidation profile requirements as shown in step 30 of FIG. 1.

With continuing reference to FIG. 2, if a student borrower 200 does not have multiple service providers, the qualification engine 210 determines at step 170 whether the borrower 210 declared multiple lenders. If multiple lenders were declared, at step 150, multiple lenders are presumed, and the qualification engine matches the borrower data against the lender consolidation loan requirements. If the borrower did not declare multiple lenders, at step 160 a single lender is presumed. Under federal requirements, if FFEL loans being consolidated are serviced by a single lender, the borrower is required to consolidate loans with that lender. Accordingly, at step 160, a search for the single lender (or companies authorized on behalf of lender) is conducted of the company data in the database, and the borrower's loan data is matched against the lender's loan requirements to determine if the borrower meets the consolidation requirements of that lender.

With continuing reference to FIG. 2, if a borrower 200 has a prior consolidation, at step 110 the qualification engine 210 determines whether the borrower has additional federal student loans to consolidate. If yes, at step 120 the multiple servicer determination is made. If the borrower does not have additional student loans at step 110, then at step 130 borrower 200 is determined not to qualify for consolidation under the FFEL program. In such instances, the borrower will be notified that their loan situation does not qualify them for consolidation.

Referring again to FIG. 1, after the qualification engine 210 matches the borrower's loan data against the lenders' requirements at step 30, at step 50 the engine displays a list of companies with whom the borrower appears to qualify based on the data entered by the borrower 200 and the requirements entered by the loan providers 205.

With further reference to FIG. 8, an embodiment of the system is implemented using HTML and Modular Gateway Interface instructions on Apple Power Macintosh G4 hardware 250 running MGI2 under the MacOS 9.2 operating system 230. Other embodiments using Intel hardware and Windows and/or Linux operating systems are easily designed using the If/Then logic described in steps 100, 110, 120, 130, 140, 150, and 160.

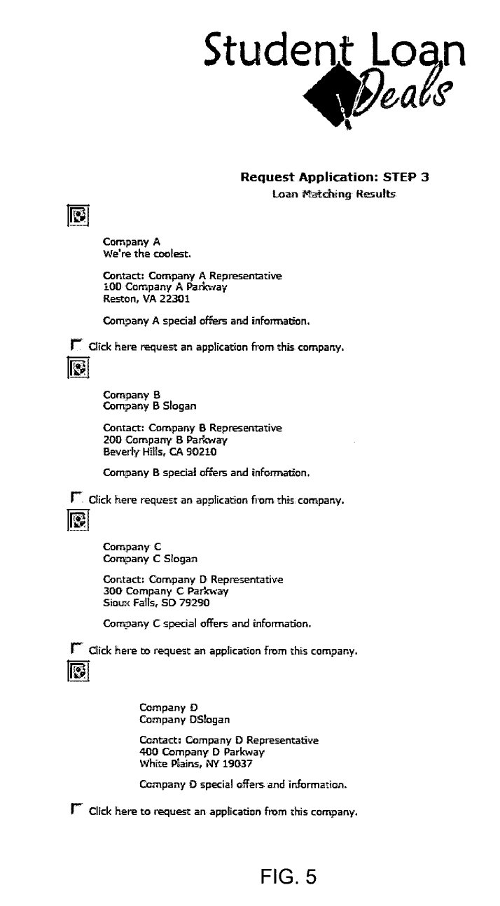

FIG. 5 shows an exemplary matching results screen available to the borrower 200 in a web browser interface to the website. In alternative embodiments, a list of matching companies could be provided via electronic mail or other forms of conventional and traditional correspondence.

In one embodiment of the invention, the borrower 200 can select a given number of matching companies from whom to receive FFEL loan application materials (such as three). In other embodiments, the borrower 200 could choose one, all or some of the matching companies from whom to receive application materials.

In embodiments of the invention, a company selected by the borrower 200 may also receive the borrower's information electronically from the database 210 connected to the website. For instance, through a secure server, after a borrower 200 selects a loan provider 205 to whom he or she would like to apply for an FFEL consolidation loan, the system of the present invention electronically transmits the data entered by the borrower 200 (FIG. 4), via the WAN 240 to the loan provider's secure database for registering the prospective borrower 200 directly with the loan provider 205 and/or electronically beginning the application process.

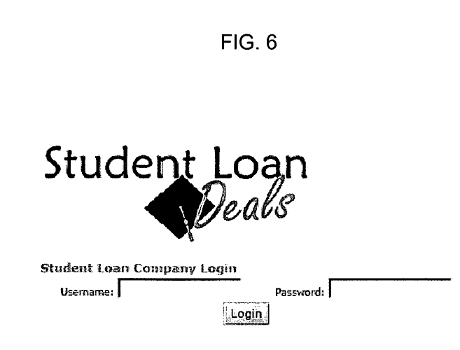

In embodiments of the invention, such as an ASP-model, loan providers 205 provide a commission or other payment for using the system. For example, in some embodiments, a tracker is provided for monitoring the number of listing matches, application requests and/or originated loans of a loan provider 205. Based on one or more of these tracked results, a loan provider 205 will pay a commission to the application service provider. A commissions calculator is provided in embodiments of the invention to determine the commissions due for a loan provider based on the tracked statistics. These statistics may also be viewed by the loan provider 205 via the loan provider interface such as shown by logging into a secure lender screen (FIG. 6) and accessing matches and application statistics as shown in FIG. 7. It will be appreciated that the tracker and commissions calculator may be provided as business logic of the database 210, or as separate modules.

Although the present invention has been described in specific detail with reference to the disclosed embodiments, it will be understood that many variations and modifications may be affected within the spirit and scope of the invention as described in the following claims.

What is claimed is:

1. A method for matching a borrower to a loan provider offering a Federal Family Education Loan consolidation program comprising:
receiving student loans' data from a borrower at a website;
receiving loan programs' criteria established for a borrower to qualify for a Federal Family Education Loan consolidation loan from each of a plurality of loan providers at the website;
comparing the student loans' data from the borrower to the loan programs' criteria of two or more of the plurality of loan providers in an electronic database; and
electronically providing a list of one or more matching loan providers that offer a Federal Family Education Loan consolidation loan for whom the borrower qualifies to the borrower.

2. The method of claim 1 further comprising receiving a commission from a loan provider originating a consolidation loan to the borrower.

3. The method of claim 1 wherein the list of one or more matching loan providers is determined by whether the borrower has any loans in default.

4. The method of claim 1 wherein the list of one or more matching loan providers is determined by whether the borrower is consolidating spousal loans.

5. The method of claim 1 wherein the list of one or more matching loan providers is determined by the borrower's outstanding balance for loans to be consolidated.

6. The method of claim 2 wherein the list of one or more matching loan providers is determined by whether the borrower has any loans in default.

7. The method of claim 2 wherein the list of one or more matching loan providers is determined by whether the borrower is consolidating spousal loans.

8. The method of claim 2 wherein the list of one or more matching loan providers is determined by the borrower's outstanding balance for loans to be consolidated.

9. The method of claim 1 further comprising determining whether a single loan provider is the only possible match to the borrower because all of the borrower's loans to be consolidated are with one loan holder.

10. A system for matching a borrower to a loan provider offering a Federal Family Education Loan consolidation program comprising:
an online prospective borrower interface to receive prospective borrower student loans' data over a wide area network;
a qualification engine connected to the wide area network for receiving the student loans' data, wherein based on the student loans' data the engine analyzes predetermined criteria of a plurality of loan providers offering a Federal Family Education Loan consolidation loan to determine whether the borrower qualifies for one or more providers' loans; and
an online reporting interface to provide the borrower a list of one or more matching loan providers with a loan program for which the borrower qualifies.

11. The system of claim 10 further comprising a tracker for monitoring the number of loan provider matches for a preselected time period.

12. The system of claim 11 further comprising a tracker for monitoring loans orginated by a matching loan provider.

13. The system of claim 10 further comprising a commissions calculator for determining commisions due from a matching loan provider.

14. The system of claim 10 wherein the predetermined criteria includes a parameter selected from the group consisting of whether a loan provider accepts defaulted loans, whether a loan provider accepts spousal consolidations parameter and the loan provider's minimum balance for consolidation parameter.

15. The system of claim 10 wherein the qualification engine wherein the predetermined criteria includes whether a loan provider accepts defaulted loans, whether a loan provider accepts spousal consolidations and the loan provider's minimum balance requirement for consolidation.
